(19) United States
(12) Patent Application Publication
(10) Pub. No.: US 2023/0398969 A1
(43) Pub. Date: Dec. 14, 2023

(54) BRAKE CONTROL SYSTEM FOR AIRCRAFT

(71) Applicant: Garrett DeVlieg, Bellevue, WA (US)

(72) Inventor: Garrett DeVlieg, Bellevue, WA (US)

(21) Appl. No.: 18/207,636

(22) Filed: Jun. 8, 2023

Related U.S. Application Data
(60) Provisional application No. 63/350,662, filed on Jun. 9, 2022.

(51) Int. Cl. B60T 8/32; B60T 8/1761; B60T 8/34; B64C 25/44

(52) U.S. Cl. CPC B60T 8/325; B60T 8/17616; B60T 8/341; B60T 8/326; B64C 25/44; B60T 2270/10; B60T 2250/04; B60T 2220/04

(57) ABSTRACT

A light weight, low cost, failsafe aircraft hydraulic brake control system featuring a park-on-return function that enables antiskid and differential brake control when selecting the parking brake for emergency braking, a paired wheel shuttle function that provides backup to a failed brake control channel without the addition of a backup brake control system, configurable as a system of identical autonomous brake control pods, each containing all the valves and sensors for controlling a subset of brakes thus limiting a worst case failure to affecting just those brakes, simplifying the hydraulic system installation and creating a complete reusable standard hydraulic brake control module.

### CROSS-REFERENCE TO RELATED APPLICATION

This application claims the benefit of U.S. provisional patent application No. 63/350,662, filed Jun. 9, 2022, incorporated herein by reference.

### BACKGROUND OF THE INVENTION

### Field of the Invention

This invention relates to mechanical systems for aircraft. More specifically, this invention relates to aircraft with brake-by-wire hydraulic braking systems.

### Description of the Related Art

Most modern braking control systems employ hydraulic brakes that are controlled by via brake-by-wire electronics. In such systems electronic signaling from the pilot's pedals is transmitted to an electronic controller that in turn commands control valves in the brake hydraulic system to apply braking. Such standard braking systems have antiskid functionality to apply effective braking without tire lockups (thus also preserving tire cornering capability) and the ability to differentially apply brake wheels on either side of the aircraft for steering, both of which are necessary to apply effective braking and control aircraft trajectory on the ground in any emergency braking situation.

Brake-by-wire systems have heretofore used a kind of arrangement for parking referred to herein as park-on-supply. In such prior art systems, a park brake switch opens a park brake valve, which applies parking pressure directly to all the brakes via a shuttle valve in each brake line, thereby engaging the park brake. In such systems, some aircraft failure conditions typically require the use of the park brake system for emergency braking. Because these park-on-supply systems apply the brakes without antiskid protection or differential braking capability, a pilot employing the park brake for emergency braking in the prior art park-on-supply aircraft has little to no control over braking effectiveness or aircraft trajectory in many emergency braking conditions, at great risk to the aircraft, its crew and passengers.

Also, these brake-by-wire hydraulic braking systems employ one of two strategies, referred to herein as inboard/outboard or primary/backup, of providing redundancy to minimize the adverse effect of failures. Inboard/outboard systems provide two independent braking systems, one for all the aircraft's inboard brakes and another for all the outboard brakes. This strategy provides an economical use of brake control valves, shutoff valves, shuttle valves, pressure sensors, and other hydraulic control components, but a single failure can result in loss of half the aircraft's brakes, which is significant and may be excessive for many aircraft. Primary/backup systems provide two independent braking systems either of which can control all the brakes. One system is for primary use and the other is for backup in case the primary system fails. This strategy provides more benign response to failures but at the expense of many idle components and the need for a critical “source select” system to de-select the failed system and select the system to be used instead.

What is needed is a park brake system that provides antiskid and differential braking capability when used for emergency braking. Also what is needed is a different strategy for arranging the brake hydraulic system components into a braking system that eliminates both the failure mode disadvantages of the inboard/outboard strategy and the excess idle components and critical source switching disadvantages of the primary/alternate strategy. The present invention addresses these needs with a brake hydraulic strategy and design that provides a more benign response to failures, can reduce system cost and weight, and offer several other advantages.

### SUMMARY OF THE INVENTION

Embodiments of this invention implement a park-on-return functionality by applying hydraulic pressure for parking via the normal brake shutoff and control valves. In contrast with prior art systems, which directly apply braking for park functionality, the present invention employs a park brake valve that simply blocks leakage out return, so that the park brake will hold after the aircraft hydraulic supply is shut off. By employing the actual brake system supply and brake pressures to actuate the valve, embodiments positively prevent inadvertent brake application.

A further embodiment of this invention groups the brake hydraulics into multiple autonomous brake control subsystems, referred to herein as “pods,” that can be arranged with a minimum of two pods per side of the aircraft for more benign failure response.

Yet a further embodiment of this invention implements a feature applicable to pods that control 2 or more brakes. A simple means, referred to herein as a “paired wheel shuttle,” is added downstream of each brake control valve to provide backup to a failed valve control channel, by switching its control to an adjacent “good” channel. Each paired wheel shuttle is actuated solely by hydraulic logic derived from the actual pressure output of the two shutoff valves, each of which is upstream of each control valve. Not only is the paired wheel shuttle beneficial in reducing the adverse effect of most brake system failure modes, but it also recovers gear retract braking to a channel whose control valve has failed, thus enhancing the ability to enable further aircraft flights until repairs can be made. The paired wheel shuttle may also allow the brake accumulator, which may likely be the only source of hydraulic power for some emergency braking conditions, to be at least 25% smaller, by implementing paired wheel control on all the aircraft brakes during such an emergency stop.

Unlike the prior art, the present invention allows normal antiskid protection during emergency braking. This is not only necessary to provide effective braking under all emergency braking conditions, but also to keep the tires rolling at or near their free-rolling speed, without which the tire cornering forces vital to maintaining on-ground directional control would be lost. Yet further, embodiments allow differential braking for directional control, of critical importance in the event that an emergency has disabled the other means of steering the aircraft. Further still, embodiments allow reversion to normal pedal braking if desired. Yet further still, embodiments can substantially mitigate the adverse result of many common failure modes.

Embodiments of the present invention can be implemented into a single autonomous hydraulic brake control module or pod that, in combination with an attached accumulator, contains all the hydraulics necessary for controlling one or a subset of brakes, thus enabling an entire brake hydraulic system to be simply comprised of identical pods. The result is a simple, light weight, low cost brake control system that provides antiskid control and differential braking when the park brake is used for emergency braking and exhibits improved and benign failure mode response.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings: all of which form a part of this specification, wherein:

FIG. 1 is a diagram illustrating the elements comprising a typical prior art embodiment of a hydraulic brake-by-wire system with a park-on-supply system;

FIG. 2a is a diagram illustrating park-on-supply hydraulic system as in FIG. 1 replaced by an embodiment of a park-on-return hydraulic system and housed in a single pod according to the present invention;

FIG. 2b illustrates the hydraulic system as in FIG. 2a with an additional brake added to the pod according to the present invention;

FIG. 3a is a diagram illustrating an inboard/outboard brake hydraulic system configuration of the prior art;

FIG. 3b is a diagram illustrating a primary/backup brake hydraulic system configuration of the prior art;

FIG. 3c illustrates an embodiment of the brake hydraulic system of the present invention implemented on an aircraft as redundant autonomous braking control modules or pods;

FIG. 4 is a general illustration of the addition of brake-by-wire controls completing a braking system comprising hydraulic pods such as illustrated in FIG. 3c;

FIGS. 5a and 5b illustrate the functional operation of the park brake valve hydraulics under brake-by-wire control in embodiments of the present invention;

FIG. 6a illustrates the configuration of the aircraft braking system in an embodiment of the present invention when parking brake is selected;

FIG. 6b illustrates the system configuration in flight when brake pedals are released and the parking brake is not selected;

FIG. 6c illustrates the system configuration in flight when one or both brake pedals are applied and the parking brake is not selected;

FIG. 6d illustrates the system configuration on the ground above a threshold speed when one or both brake pedals are applied and the parking brake is not selected;

FIG. 6e illustrates the system configuration on the ground below a threshold speed when one or both brake pedals are applied and the parking brake is not selected;

FIG. 6f illustrates the system configuration on the ground below a threshold speed when neither brake pedal is applied and the parking brake is selected;

FIG. 6g illustrates the system configuration on the ground when the parking brake is selected and all but battery power is shut off;

FIG. 6h illustrates the system configuration on the ground above a threshold speed when one or both brake pedals are applied as for emergency braking but the parking brake is not selected;

FIG. 6i illustrates the system configuration in flight when neither brake pedal is applied but the parking brake is selected;

FIG. 6j illustrates the system configuration on the ground above a threshold speed when neither brake pedal is applied but the parking brake is selected;

FIG. 6k illustrates the system configuration on the ground above a threshold speed, the parking brake is selected, and one or both brake pedals are applied;

FIG. 6l illustrates the system configuration on the ground transitioning from above to below a threshold speed with the parking brake selected and neither brake pedal applied;

FIG. 6m illustrates the system configuration on the ground below a threshold speed with parking brake selected and brake pedals applied, as when the pilot has brought the aircraft to a full stop;

FIG. 7a illustrates an embodiment of a pod with 2 brakes as depicted in FIG. 2b, but with a paired wheel shuttle added to one brake control channel according to the invention;

FIG. 7b shows the embodiment of FIG. 7a with a paired wheel shuttle added to both brake control channels according to the invention;

FIG. 8a illustrates an embodiment of a two brake hydraulic system without a paired wheel shuttle, such as that in FIG. 2b, having a brake control failure affecting of one of the two control valves; and

FIG. 8b illustrates an embodiment of a two brake hydraulic system having paired wheel shuttles, such as that depicted in FIG. 7b, having a brake control failure affecting of one of the two control valves.

### DETAILED DESCRIPTION OF THE INVENTION

In hydraulic braking systems in general, braking is achieved by hydraulic braking pressure applied to wheel-brake assemblies of the vehicle. In aircraft brake-by-wire braking systems, an electronic control valve delivers brake pressure in response to a brake application command supplied by the pilot or other airplane systems, minus any brake pressure reduction commanded by antiskid if the brake application command would otherwise excessively skid the tire.

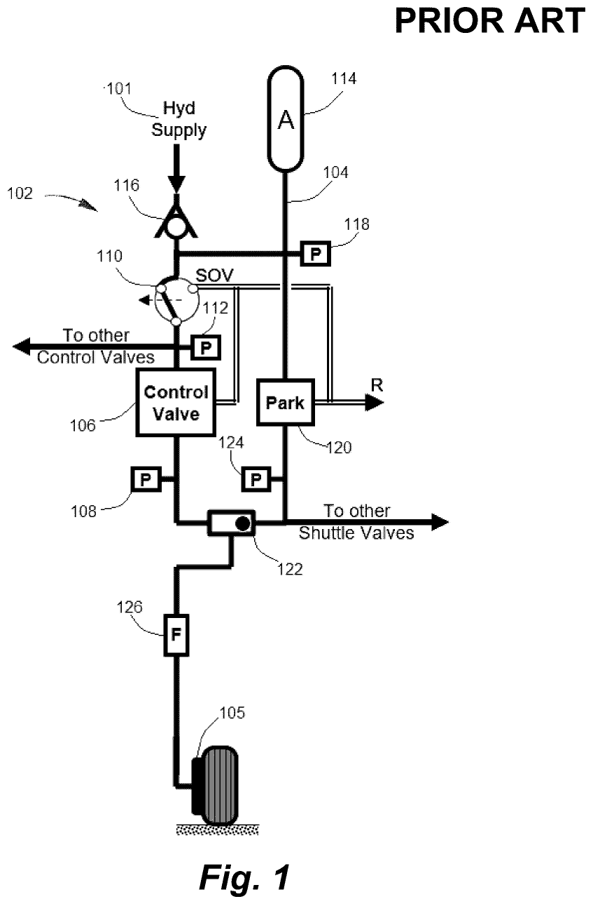

In FIG. 1, a brake-by-wire hydraulic system 102 according to the prior art comprises a brake system hydraulic supply 104 of hydraulic fluid for action upon wheel-brake assembly 105. At least one control valve 106 provides brake pressure control in response to a brake application command, modified for antiskid as described above. Control valve pressure sensor 108 provides pressure control feedback and fault monitoring for control valve 106. The system further comprises shutoff valve 110 to depressurize control valve 106 when not in use and to positively prevent inadvertent brake application. Shutoff valve pressure sensor 112 provides fault monitoring for shutoff valve 110.

The system also comprises accumulator 114, providing a stored energy source for emergency braking and enabling park brake “hold”. Coupled with accumulator 114 is inlet check valve 116 to trap aircraft hydraulic supply pressure in accumulator 114 when the aircraft hydraulic supply 101 is shut off or lost. Accumulator pressure sensor 118 monitors the hydraulic pressure provided by the brake system hydraulic supply 104.

As illustrated, the park brake employs a park-on-supply design. Park brake valve 120 applies parking pressure routed through shuttle valve 122 toward its associated wheel-brake assembly 105. It is characteristic of such systems that the park brake pressure overrides the brake pressure from control valve 106, and the brake cannot be released, such as to prevent a locked tire, without releasing the park brake. Park brake valve pressure sensor 124 provides fault monitoring for park brake valve 120. Hydraulic fuse 126 is provided to minimize hydraulic fluid loss in the event of a brake line rupture.

Significantly, on aircraft with 4 or more braked wheels, such prior art systems share both the control valve enabling pressure from the shutoff valve and the parking pressure from the park brake valve over multiple brake-wheel assemblies. This sharing provides a modest economy of parts required by the entire aircraft braking system, but at the expense of single failures that affect multiple brakes and significant added tubing and fittings resulting in added cost, weight, and exposure to external threats to the tubing's integrity.

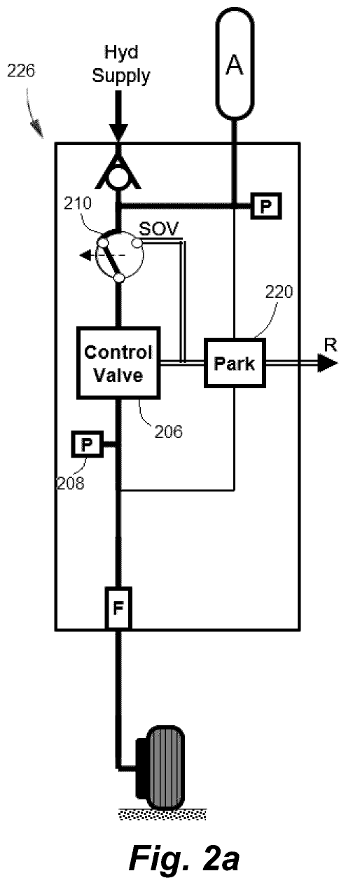

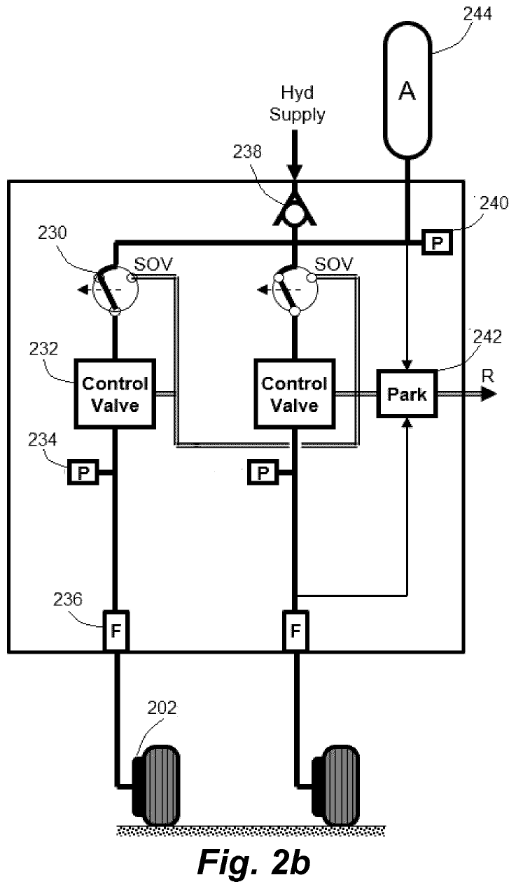

Turning to FIG. 2a, a park-on-return hydraulic system is shown according to an embodiment of the present invention. In contrast to the park-on-supply system of FIG. 1, the park brake valve 220 itself no longer applies the brakes. Instead, the park brake valve 220 is a simple two-stage, pressure biased shutoff valve that blocks the brake system return to trap pilot-applied parking pressure in the brakes. When the park brake is not commanded to be set, brake system supply pressure physically holds its park brake valve 220 open to positively prevent an unwanted brake application, which could be extremely hazardous in certain situations such as during takeoff. The brake pressure is monitored by control valve pressure sensor 208, so the park brake pressure sensor 124 and park brake shuttle valves 122 of the FIG. 1 park-on-supply system are no longer required. To close the park brake valve, near maximum brake pressure must be applied via the normal fail-safe brake controls (shutoff valve 210 in series with the brake control valve 206). Simple electronic controls prevent commanding the park brake valve to close unless the aircraft is essentially stationary, and emergency braking can be applied via normal pedal application, autobraking, or the park brake switch—all with antiskid protection and differential braking capability.

In such embodiments, in general the prior art hydraulic lines porting the control valve enabling pressure from the shutoff valve and the parking pressure from the park brake valve over multiple brake-wheel assemblies are eliminated. The shutoff valve pressure sensors of the prior art, such as shutoff valve pressure sensor 112 and park brake pressure sensor 124 in FIG. 1, can be eliminated, since the shutoff valve's integrity could now be monitored via the control valve pressure sensor 208. Also the park brake shuttle valve 122 for each brake can now be eliminated, and the shutoff valve 110 can be downsized as it needs only provide flow to one brake control valve.

As a result of the components all being located adjacent to each other and all hydraulically connected to only each other, they can now be grouped into a single brake control valve module 226, except for the accumulator which would be dedicated to the module but attach separately. This deletes the considerable amount of hydraulic tubing required by the prior art to interconnect multiple independent components. Module 226 is thus an autonomous brake control “pod” that advantageously limits the adverse effect of failures to just the brake or brakes controlled by that pod, not allowing those failures to propagate their adverse effect to other aircraft brakes by way of sharing.

Referring to FIG. 2b, additional brakes can be added to the embodiment depicted in FIG. 2a, creating a pod for plurality of brakes. To add each additional brake 202 to a pod, only an additional shutoff valve 230, control valve 232, pressure sensor 234, and brake line fuse 236 are added. The inlet check valve 238, brake system supply pressure sensor 240, and park brake valve 242 are shared by all the brakes controlled by that pod. The accumulator 244 is also shared by all the brakes in that pod but needs to be resized to accommodate the additional brakes.

As additional brakes are added to a pod, only one of the brakes provides brake pressure hydraulic logic to the park brake valve 242. This is not a problem. For example, assuming a 2 brake pod and the minimum of 4 pods per aircraft (2 per side), a failure of that one brake control channel would still apply parking pressure to all but the failed brake, i.e. to 7 of the 8 aircraft brakes, and 6 of the 8 aircraft brakes would still hold long after the aircraft hydraulic systems have been shut down—an acceptable result.

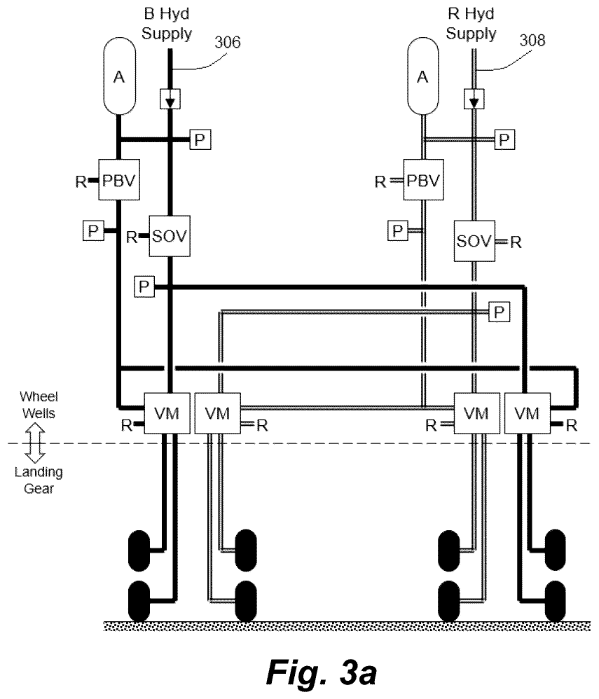

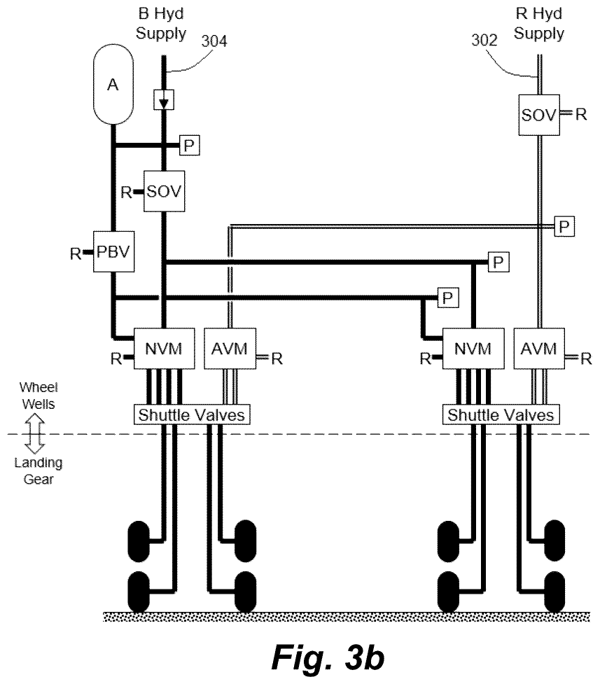

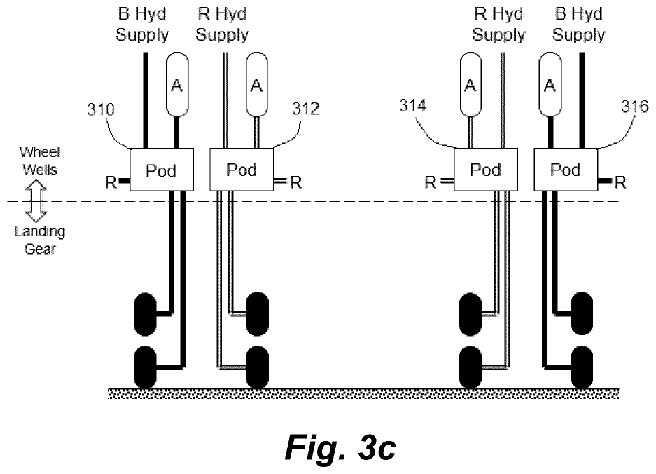

FIGS. 3a and 3b illustrate two different prior art total aircraft brake hydraulic system installations for an airplane having eight brakes. As will be familiar to those in the art, FIG. 3a illustrates an inboard/outboard configuration and FIG. 3b illustrates a primary/backup configuration. These two alternative configurations are the means used in the prior art for achieving redundancy when configuring an aircraft brake control system to meet failure mode requirements.

Inboard/outboard provides one independent brake system 302 for all the inboard brakes and another brake system 304 for all the outboards, thus limiting the loss of one system to the loss of half the brakes. Primary/backup came into existence because a single failure condition that loses half the brakes is not acceptable for many modern aircraft. Primary/backup provides two independent braking systems, 306, 308, either of which can control all the brakes. The primary system 306 normally applies the brakes, but in the event of certain failures the primary system is shut off and the backup system 308 selected instead. This results in the consequence of failures being more benign, but adds the cost and weight of numerous idle parts. This also requires a critical electronically controlled source switching system to ensure that the “failed” system will always be shut off and the “good” system will always be selected.

In contrast to the prior art illustrated in FIGS. 3a and 3b, FIG. 3c illustrates the simplicity that results from the reduction of hydraulic connections and components facilitated by the redundant modularization of braking systems in embodiments of the present invention. Embodiments of the present invention provide at least two pods 310, 312 and 314, 316 on each side of the aircraft, thereby limiting the effect of a worst case failure to loss of half the brakes on only one side, thus limiting the loss of braking capability to 25% and ensuring that differential braking capability is retained—an acceptable worst case failure result. With respect to an inboard/outboard system as illustrated in FIG. 3a, the system of the present invention in FIG. 3c adds some component cost and weight which is then offset by the savings in tubing and component installations, to the extent that an overall savings in cost and weight should result—and a much more benign response to failures. With respect to a primary/backup system as illustrated in FIG. 3b, the system of the present invention in FIG. 3c saves the considerable cost and weight of the components, tubing, and component installations—while achieving an equally benign response to failures.

In addition, the pods greatly reduce the exposure of brake hydraulic components and tubing to external damage from tire failures or other projectiles that might otherwise result in the complete loss of all braking capability—an important safety advantage. Finally, the pods create the opportunity to implement other improvements according to this invention that greatly increase the brake system control under emergency braking conditions, as well as significantly more benign failure response.

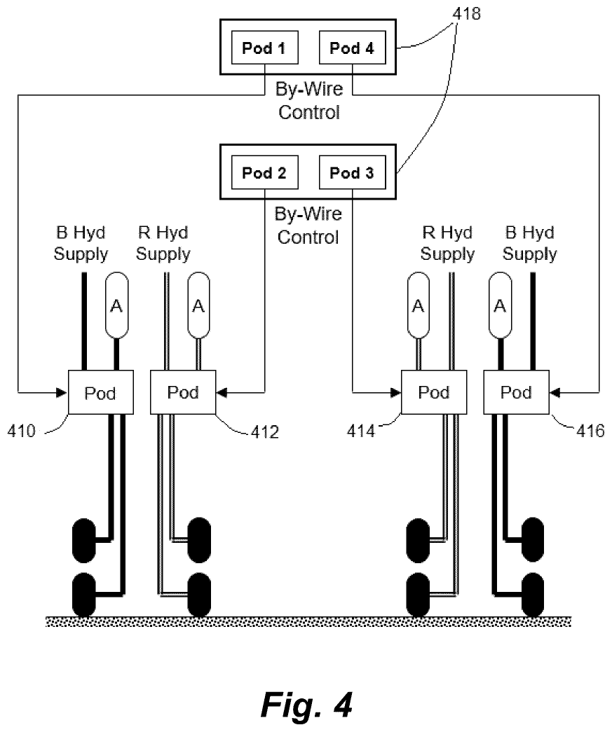

FIG. 4 is a general depiction of the pods hydraulic system of FIG. 3c showing the addition of electronic controls. The electronic controls 418 for pods 410, 412, 414, and 416 can also be autonomous and dedicated to their respective hydraulic pod, thus extending the concept of autonomous brake control pods to include the brake-by-wire electronic controls. This limits a worst case brake control failure to adversely affecting no more than 25% of the braking capability.

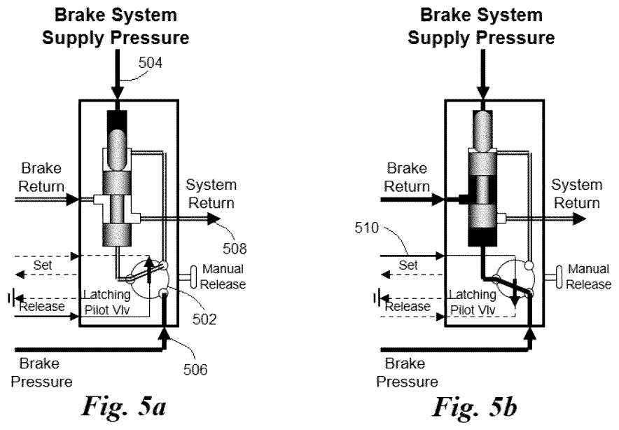

We turn now to details of operation of hydraulics in park-on-return embodiments, such as illustrated in FIGS. 2a and 2b, in response to brake-by-wire control. FIGS. 5a and 5b illustrate the functional operation of the park brake valve in such embodiments. In FIG. 5a, park brake valve 502 is normally open, and is positively held open by brake system supply pressure 504. An electrical command to close the valve is only provided when the Emergency/Park brake switch is selected and aircraft sensors indicate the aircraft is nearly stopped on the ground. In that case the park brake control electronics 510 command the valve 502 to close as depicted in FIG. 5b, but valve 502 will close only if the applied brake pressure 506 approaches the brake system supply pressure 504 as determined by the end area ratio of valve 502. In embodiments, valve 502 closes when applied brake pressure 506 is approximately 70 to 90% of brake system supply pressure 504. Normal brake applications are not nearly this high, so this gives further protection against an unintentional brake application closing the park brake valve. When valve 502 closes, brake system return flow 508 is blocked, trapping the accumulator pressure in the brakes and preventing bleed-down of the accumulator via control valve or shutoff valve leakage.

By applying the parking pressure via the normal brake controls and by not commanding the park brake valve to close until the aircraft is nearly stopped, the park brake can be used for emergency braking without sacrificing antiskid control and differential braking capability—both of which can be vital to safely performing an emergency stop. Also, a failure of the prior art park-on-supply system resulting in inadvertent park brake application could be catastrophic if it were to occur in some situations such as during takeoff. The park-on-return system of the invention incorporates both electronic and hydraulic safeguards to absolutely prevent this failure condition.

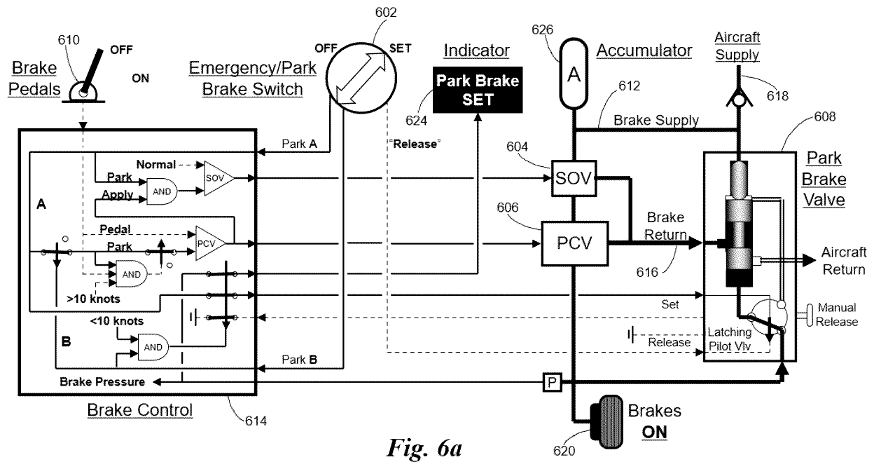

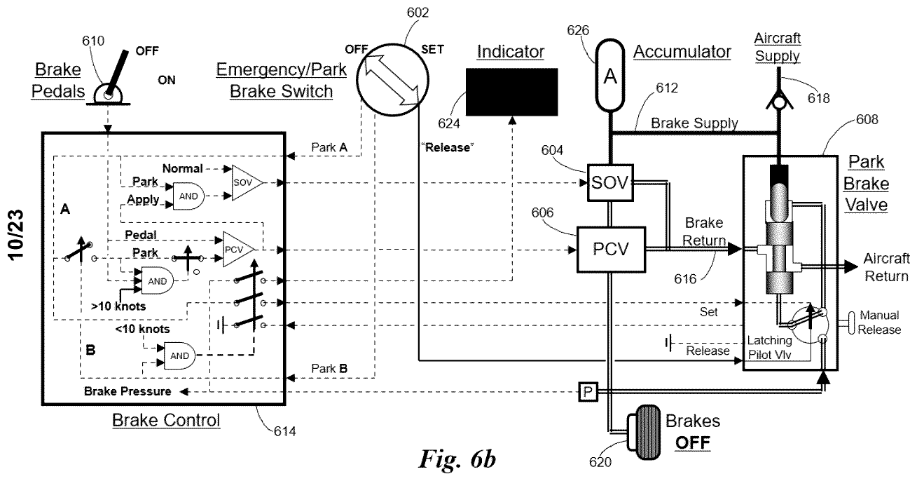

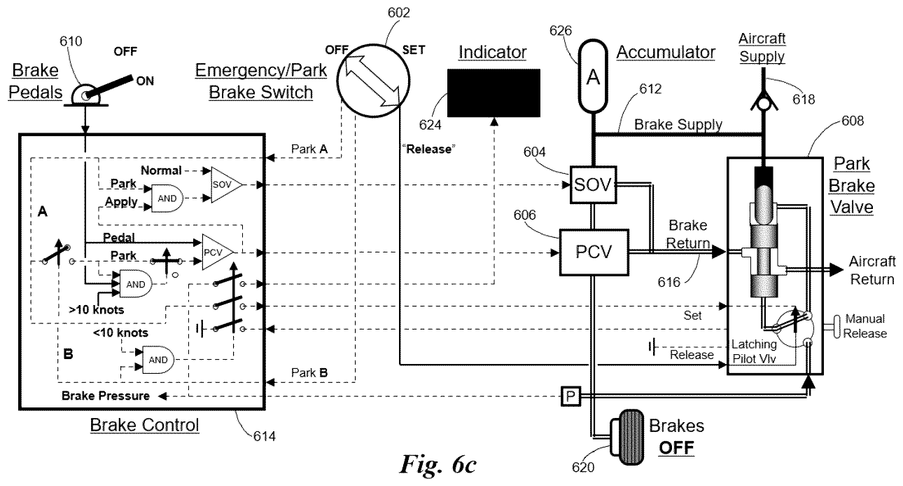

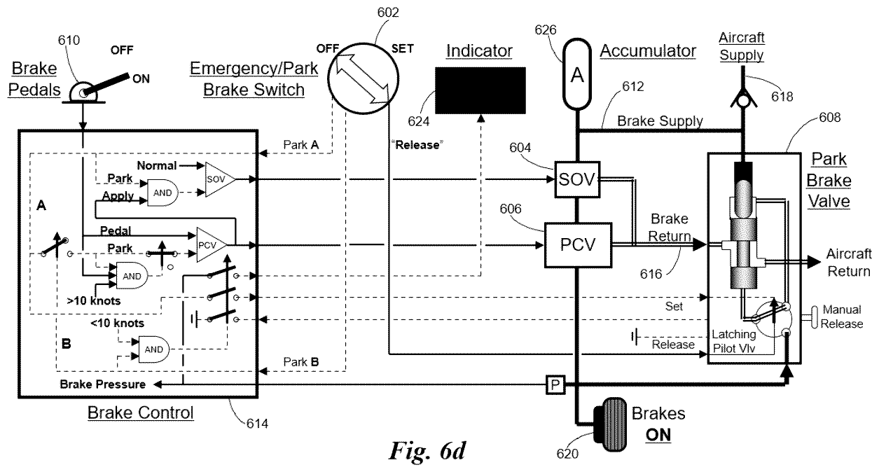

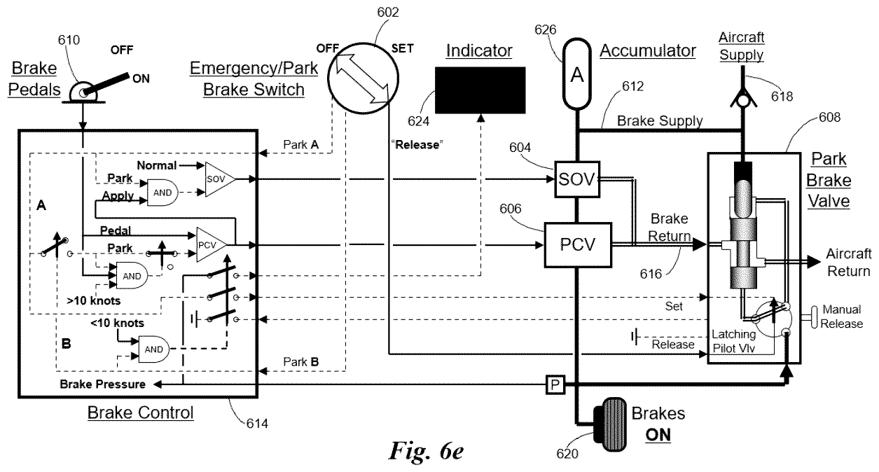

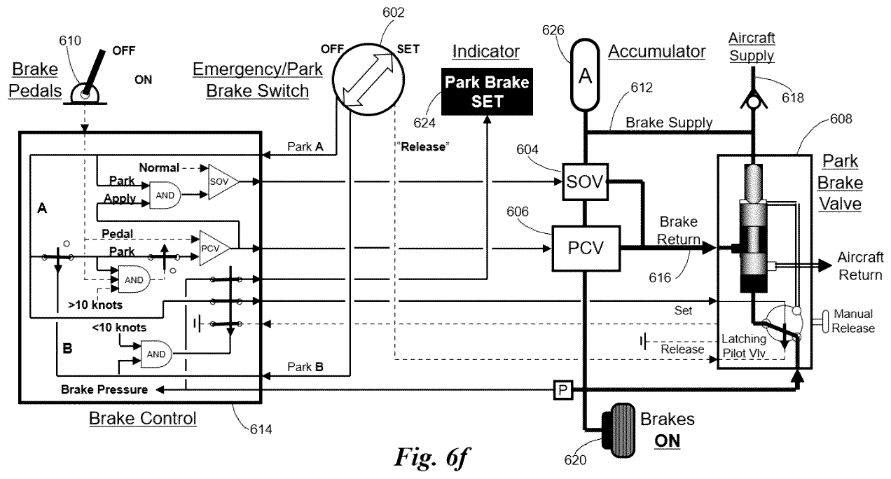

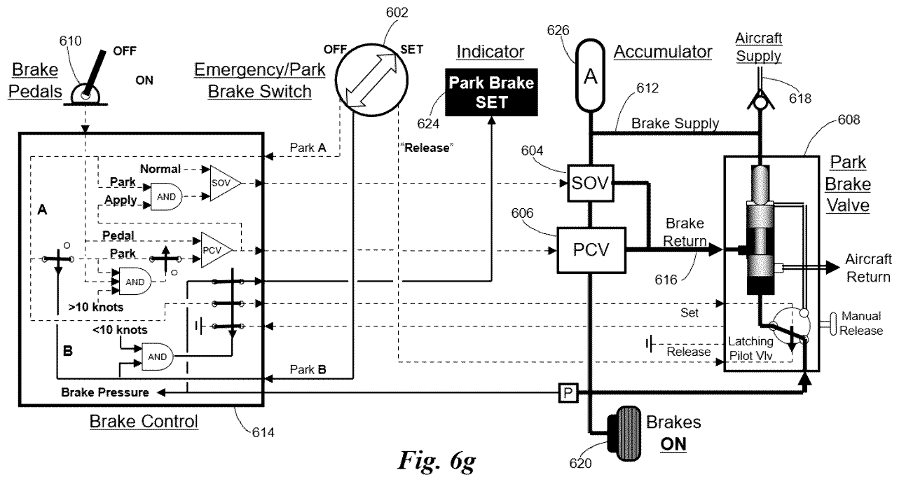

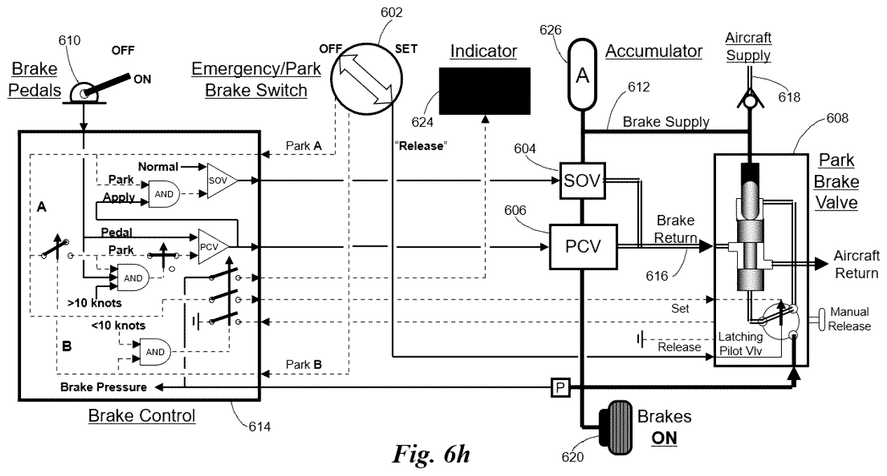

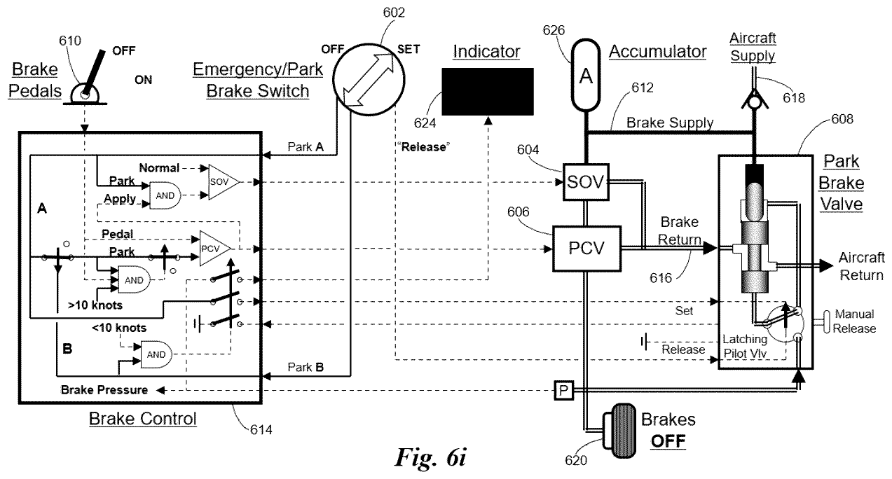

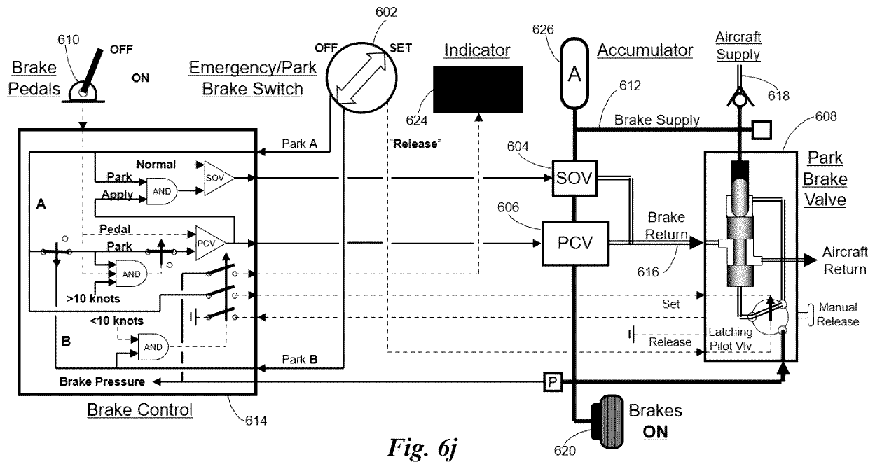

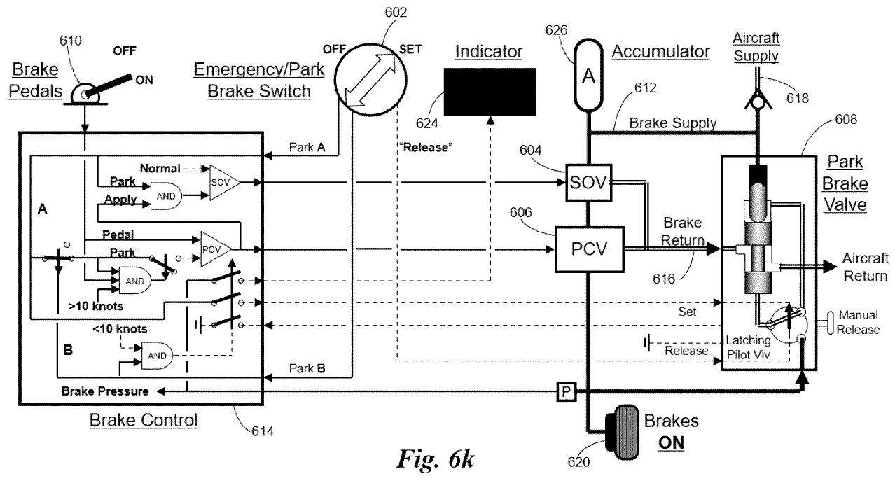

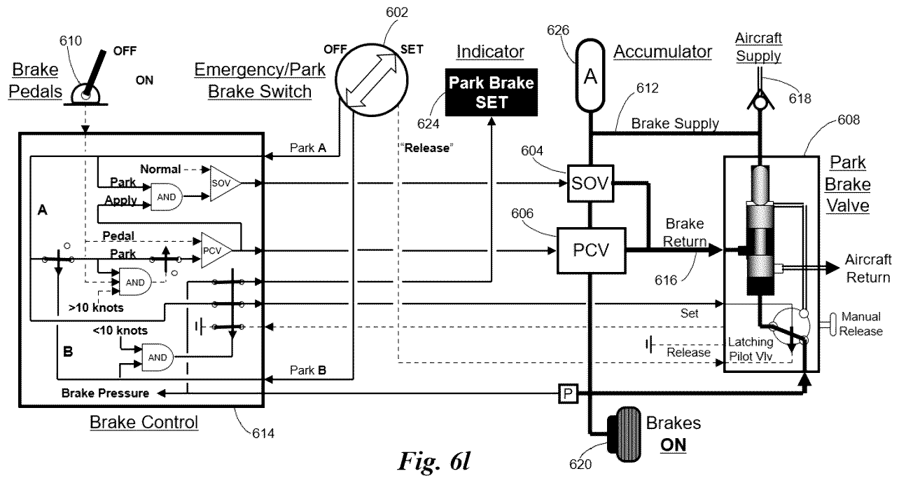

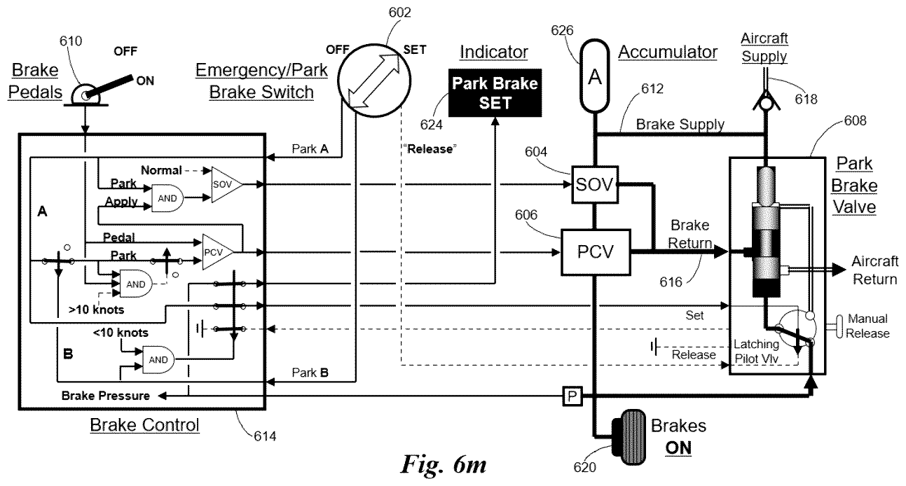

FIG. 6a illustrates a general configuration of an embodiment of a park-on-return in a brake-by-wire hydraulic braking system with park braking engaged. The pilot selects the park brake via park brake selector switch 602, which applies the brakes via the shutoff valves 604 and the brake control valves 606. If the aircraft is rolling (exceeding an antiskid reference speed, 10 knots as illustrated for this embodiment), the park brake valve 608 remains open so that parking pressure is applied with antiskid protection. Advantageously, braking with antiskid protection can instead be applied via pedal 610 during this time if needed for differential braking or otherwise desired, then return to the parking pressure (with antiskid) if pedal braking via pedal 610 is released. The park brake is “set” when emergency/park pressure is applied and the aircraft is essentially stopped (as indicated by an antiskid reference speed), by commanding park brake valve 608 to close, thereby trapping pressure in accumulator 626 for park brake “hold”. If desired, the application of park brake pressure may be ramped up to prevent too sudden an application and/or be set to control a value less than full brake system supply pressure. Park brake indicator 624 is on when the park brake is “set”. The park brake remains “set”, even if all electric and hydraulic power is shut off, until commanded by the park brake selector switch 602 to “release”.

With park-on-return, as illustrated, the brakes are applied via the fail-safe normal brake control system 614. The park brake valve 608 will close to block brake system return 616 only when the park brake is selected via both the “Park A” and “Park B” commands from park brake selector switch 602 and the aircraft is essentially stopped—and then only to hold the park brake on and to prevent bleed-down of accumulator 626 after the aircraft hydraulic supply 618 is shut off.

Turning to FIG. 6b, a system configuration is depicted for the embodiment in FIG. 6a, but in flight with park brake selector switch 602 off and the pedals 610 released. Shutoff valve 604 is closed, waiting for brake application. Brake system return 616 is positively held open by brake system supply pressure.

FIG. 6c illustrates a configuration as in FIG. 6b, but shown with one or both pedals 610 applied while in flight. Features typically existent in the antiskid system of brake control system 614 prevent brake application until the wheels have spun up after touchdown. Shutoff valve 604 is closed and control valve 606 is not commanding brake application, both waiting for brake application to be allowed.

FIG. 6d illustrates the configuration with one or both pedals 610 applied on the ground after the antiskid has allowed brake application but before the aircraft has stopped (here illustrated as above an antiskid reference speed of approximately 10 knots). Normal pedal braking is applied and normal differential braking capability and antiskid protection are provided via brake control system 614. Normal pedal braking may be used for emergencies as well as aircraft steering. The brake system return 616 is positively held open by the brake system supply pressure.

FIG. 6e illustrates the configuration as depicted in FIG. 6d, but for an aircraft stopped (here illustrated as below an antiskid reference speed of approximately 10 knots). The brake system return 616 is positively held open by the brake system supply pressure.

FIG. 6f illustrates a configuration with the park brake set, as applied for an aircraft stopped (here illustrated as below an antiskid reference speed of approximately 10 knots). Emergency/Park brake has been selected via park brake selector switch 602. Being essentially stopped, park brake valve 608 is commanded to close, whether the brake pedals are applied or not. The parking pressure in brakes 620 overcomes the brake system supply pressure 612, so park brake valve 608 closes, thereby trapping the accumulator pressure in the brakes, setting the park brake, and turning park brake indicator 624 on. The park brake remains “set” until commanded by the park brake selector to “release”.

Most aircraft apply the maximum hydraulic supply pressure for parking. However some may wish to apply a lesser parking pressure to limit the stress on hot brakes. This may be done by adding logic to the signal that commands park brake valve 608 to close, such that the park brake valve will not be commanded to close until the brake system supply pressure 612 has decayed to equal the lesser parking pressure. While the aircraft hydraulic supply is on, the park brake valve will remain open to allow the pressure in brakes 620 to be controlled to the lower parking pressure. When the aircraft hydraulic supply is shut off, the quiescent leakage through the brake control valves 606 will begin consuming the fluid stored in accumulator 626, thus reducing the brake system supply pressure 612. After some seconds, the brake system supply pressure will decay to equal the lesser parking pressure. At that point the park brake valve will be commanded to close, thus “setting” the park brake and holding the pressure in brakes 620 at the lesser parking pressure.

FIG. 6g illustrates a configuration with the park brake set via park brake selector switch 602 and with all but the aircraft battery powered off. The park brake remains “set”. Park brake valve 608 remains latched closed. The supply pressure 612 from accumulator 626 keeps the brakes applied. When closed, park brake valve 608 is sufficiently leak-tight to preserve the accumulator pressure. Battery power keeps park brake indicator 624 on.

FIG. 6h illustrates a configuration employing emergency braking with one or both brake pedals 610 and Emergency/Park brake not selected. Pedal braking and the park brake work exactly the same when used for normal braking. Normal antiskid protection and differential braking capability are provided. If braking on accumulator 626, the maximum available braking drops as the accumulator 626 depletes. Accordingly, accumulator 626 must be sized so that it will not fully deplete. The parking pressure is limited to the pressure remaining in accumulator 626.

FIG. 6i illustrates a configuration with park brake selector switch 602 selected in-flight. Most if not all modern aircraft employ antiskid “touchdown” or “hydroplane” protection in brake control system 614 to prevent brake application until wheel spin up. This is to prevent tire lockups due to too early brake application. Shutoff valve 604 is closed and control valve 606 is not commanding brake application, both waiting for brake control system 614 to enable brake application. Park brake valve 608 is not commanded to close. Brake system return 616 is positively held open by brake system supply pressure. Brake control system 614 does not enable illumination of park brake indicator 624.

FIG. 6j shows Emergency/Park braking selected when rolling on the ground (here illustrated as above an antiskid reference speed of approximately 10 knots). Once the wheels have spun up, the antiskid system in brake control system 614 allows emergency park pressure to be applied via brake control valve 606 to all the brakes. Normal antiskid protection then maximizes braking without allowing excess tire skidding. Although park brake selector switch 602 is selected, the park brake is not actually “set’ so the park brake indicator 624 is not on. As is the case for emergency pedal braking, if braking on the accumulator 626, the maximum available braking drops as accumulator 626 depletes, and the available parking pressure will be limited to the pressure remaining in accumulator 626.

FIG. 6k illustrates application of pedal braking when Emergency/Park braking is employed while rolling on the ground (here illustrated as above an antiskid reference speed of approximately 10 knots). Here, one or both of brake pedals 610 are engaged while park brake selector switch 602 is set. In an emergency, differential braking may be needed for directional control. Advantageously, applying either pedal 610 beyond a threshold gives priority to normal pedal braking over park brake, whereby differential braking may be applied while normal antiskid continues to be provided by way of brake control system 614. When brake pedals 610 are released, the system will again return to the state illustrated in FIG. 6j. In any case, if braking on accumulator 626, the maximum available braking pressure drops as accumulator 626 depletes, and the available parking pressure will be limited to the pressure remaining in accumulator 626.

FIG. 6l illustrates Emergency/Park braking transition from above to below a speed threshold indicative of the aircraft being stopped (here illustrated as an antiskid reference speed of approximately 10 knots). At speeds below this threshold, when park brake selector switch 602 is set, brake control system 614 enables the park brake to “set.” The antiskid “drops out” at about this speed, so the brake pressure ramps up to the full parking pressure if is not already there. This closes park brake valve 608, tightly shutting off flow to brake system return 616 and turns on the park brake indicator 624. With brake system return 616 now blocked, the brake pressure ramps up further to brake system supply pressure 612 if it was not already there.

FIG. 6m illustrates Emergency/Park braking when one or both pedals 610 are applied to full stop. Upon the coming to a stop (here illustrated as an antiskid reference speed of approximately 10 knots) the park brake “sets”. The pedal braking command is removed and park brake pressure commanded. The antiskid “drops out” at about this speed, so the brake pressure ramps up to the parking pressure if is not already there. This closes park brake valve 608, tightly shutting off flow to brake system return 616 and turns on the park brake indicator 624. With brake system return 616 now blocked, the brake pressure ramps up further to brake system supply pressure 612 if it was not already there.

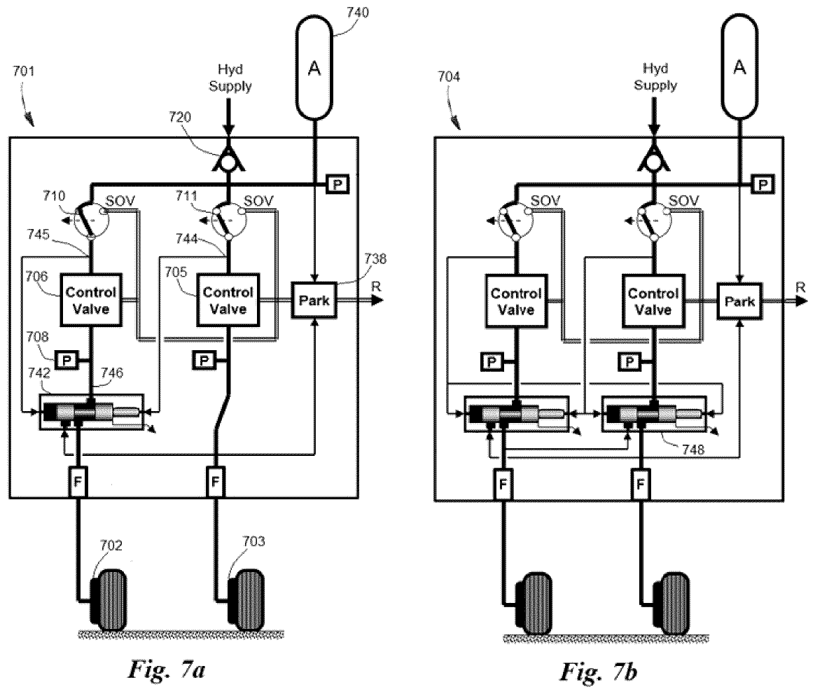

FIGS. 7a and 7b generally illustrate the pod of FIG. 2b for two brakes, with the addition of “paired wheel shuttles.”

FIG. 7a shows the addition of a paired wheel shuttle to the first brake control channel in the pod 701. The paired wheel shuttle 742 is a simple pressure-based hydraulic shuttle valve which is inserted into the brake pressure line downstream of brake pressure sensor 708. Its normally open brake port is connected to brake 702 and its normally blocked brake port is connected to the brake pressure 703 of the adjacent brake control channel. Shutoff valve output pressure 745, which enables control valve 706 is routed to its large area sensing port, and shutoff valve output pressure 744, which enables the adjacent control valve 705 is routed to its small area sensing port. These two pressures, in combination with the area ratio of the sensing ports, provide the hydraulic logic to actuate the paired wheel shuttle.

FIG. 7b illustrates the addition of a paired wheel shuttle 748 to the second brake control channel in the pod 704. The second paired wheel shuttle 748 is added in the same manner as that shown in FIG. 7a. Importantly, each shutoff valve's output pressure is routed to the large area sensing port on its respective paired wheel shuttle. This positively ensures that, as long as a brake's shutoff valve is open to enable braking, its respective paired wheel shuttle will route brake control pressure to its respective brake and block the control pressure from the adjacent brake.

A most important factor in any brake control system design is its response to failures. Before addressing this for the present invention, an overview of how prior art braking systems respond to brake system failures warranted.

For antiskid-only failures (typically just wheel speed sensing failures) the failure just affects the brake release command from the antiskid and does not affect the ability to control the brake pressure. So prior art systems only shut off the associated brake control valve, thus preventing a wheel lockup, and the upstream shutoff valve is left open to enable the other brake control valves that share that same shutoff valve to continue to operate normally. This shuts off just that brake during normal braking, but still leaves the brake available to stop the wheel before it enters the wheel well after takeoff, because antiskid is not required for this function. This is an acceptable result. The system of the present invention responds to an antiskid-only failure the same way.

Brake control failures constitute the majority of brake system failure modes. Prior art systems typically respond by shutting off the associated brake control valve and, under the assumption that the failure may prevent the control valve from dumping the brake, also shutting off the upstream shutoff valve to prevent wheel lockups.

On prior art inboard/outboard systems this would result in a 50% loss of braking, which is an undesirable result. Some inboard/outboard systems may only shut off the brake control valve and risk a wheel lockup and tire blowout, which is also an undesirable result.

On prior art primary/backup systems, the primary system shutoff valve is shut off, and at the same time the backup system shutoff valve must be opened to regain brake control via the backup system. Backup systems typically employ paired-wheel antiskid control, which simply applies the larger of the two brake pressure reductions commanded by each individual antiskid to both brakes. This restores antiskid-controlled braking to all the wheels, although at the expense of a modest loss in antiskid-controlled braking due to half the brakes operating below their optimum pressure level. Also some functions may not be available on the backup system such as automatic braking, gear retraction braking, and parking. This is an acceptable but not ideal result.

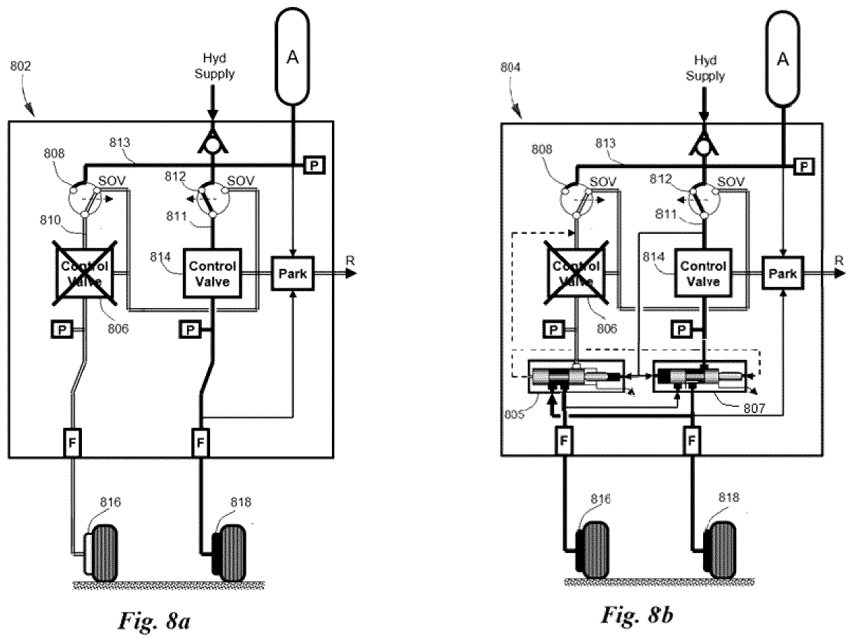

FIG. 8a depicts a two 2-brake pod 802 without paired wheel shuttles, illustrating its response to a control channel failure. For illustration purposes, the control channel failure is indicated by an “X” over control valve 806. Like prior art systems, the brake system fault monitor shuts off both shutoff valve 808 and control valve 806, thus redundantly ensuring that brake 816 is released. Meanwhile shutoff valve 812 and brake control valve 814 for the other “good” brake 818 remain open. The result is that brake 816 is shut off and all other brakes are unaffected. This is similar to but considerably more benign than prior art inboard/outboard systems, because only the affected brake will be released and there is no risk of a tire lockup or blown tire.

FIG. 8b depicts a 2-brake pod 804 with paired wheel shuttles, illustrating its response to a control channel failure. For illustration purposes, the control channel failure is indicated by an “X” over control valve 806. Again, like prior art systems, the brake system fault monitor shuts off both shutoff valve 808 and control valve 806, and, with paired wheel shuttles installed, also implements paired wheel antiskid control for the two brakes. Looking at the “failed” channel, shutoff valve 808 is now shut off. So the pressure from adjacent shutoff valve 812 to the small area on the paired wheel shuttle moves the shuttle 805 to block brake 816 access to its “failed” control channel and instead provide brake 816 access to the “good” control channel for adjacent brake 818. The antiskid of the “failed” brake is still OK, so at the same time the fault monitor implements paired wheel antiskid protection to both brakes. Control of brake 816 is now restored, with “good” control valve 814 now controlling both brakes with paired wheel antiskid. The result is that all braking functions to all aircraft brakes are retained, except just those two brakes operate with paired wheel antiskid control. This is similar to but more benign than prior art primary/backup systems, because all braking functions are retained and only 25% of the brakes operate with paired wheel antiskid instead of 100%.

Persons of skill in the art will appreciate that each paired wheel shuttle is actuated solely by hydraulic logic derived from the pressure output of the two shutoff valves, one each already upstream of each control valve, and that no added tubing or wiring is required. Not only is the paired wheel shuttle beneficial in reducing the adverse effect of most brake system failure modes, but it also recovers gear retract braking to a failed channel thus enhancing the ability to enable further aircraft flights until repairs can be made.

The paired wheel shuttle can also be implemented in a pod controlling 3 or more brakes. Assuming a pod controlling 3 brakes with a first, second and third control valve, the paired wheel shuttles can be connected with the first valve's shuttle backing up the second valve, the second valve's shuttle backing up the third valve, and the third valve's shuttle backing up the first valve. For a pod controlling 4 brakes, the first two brakes can back each other up and the second two brakes can back each other up. Persons of skill in the art will understand how, for a pod controlling any number of a plurality of brakes, a corresponding number of paired wheel shuttles may be employed in a like manner.

Note that with the paired wheel shuttles installed, the park brake can now be set on all brakes despite any brake control channel having failed. As a further advantage the brake system control system can now be configured to implement paired wheel control whenever an emergency stop must be conducted on just brake accumulator pressure. Implementing paired wheel control shuts off half the control valves thereby reducing each pod's total quiescent control valve leakage by half. Each brake accumulator can therefore be at least 25% smaller, with resulting meaningful savings in costs and weight.

The present invention provides an aircraft braking system that enables antiskid control and/or differential braking when using the park brake for emergency braking, a capability not present in the prior brake-by-wire art hydraulic braking systems. Thereby, embodiments of this invention retain effective braking and directional control capability over the range of possible emergency braking conditions, at great safety benefit to the aircraft, its crew and passengers.

Persons of skill in the art will note that in embodiments of this invention, Emergency/Park can even be selected before landing, provided that the aircraft's antiskid system employs a feature which prevents brake application until an antiskid “wheel speed reference” is provided, a feature which is already common on aircraft antiskid systems. Upon landing, such embodiments can then automatically apply parking pressure as soon as antiskid is available. In such a situation, since parking pressure is applied via the normal brake control system, the pressure application can be controlled to be smooth to facilitate nose touchdown and applied to a level less than maximum.

The braking system of the present invention may be embodied in modules, or pods, in a reusable design over many different aircraft models, greatly reducing cost, development time and risk, and system certification time and cost. Further, implementation of the braking system in reusable, serviceable pods standardizes and reduces maintenance requirements and cost in such embodiments.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the modifications and equivalents. The invention is limited only by the following claims and their equivalents.

I claim:

1. A hydraulic braking system for an aircraft, comprising:
one or more hydraulically actuated brakes;
a brake system hydraulic supply, providing a brake system hydraulic pressure to the hydraulic braking system;
an accumulator and check valve in combination for maintaining the brake system hydraulic pressure;
a brake system hydraulic return;
an aircraft system hydraulic return;
a crew-controlled park brake selector;
an electronic brake system controller;
a brake control valve powered by said brake system hydraulic pressure and responsive to the electronic brake system controller to apply a braking pressure to the one or more hydraulically actuated brakes;
the electronic brake system controller configured, responsive to a park-select signal from the crew-controlled park brake selector, to send a parking signal to the brake control valve to apply a parking pressure minus correction from an antiskid functionality;
a park-on-return valve hydraulically interposed between the brake system hydraulic return and the aircraft system hydraulic return, the park-on-return valve being normally open thereby returning the brake system hydraulic return to the aircraft system hydraulic return;
said the electronic brake system controller sends the parking signal causing the park-on-return valve to close when the crew-controlled park brake selector is actuated, the speed of the aircraft is below a threshold speed value, and the braking pressure exceeds a percentage of the brake system hydraulic pressure, the park-on-return valve thereby blocking the brake system hydraulic return to trap the brake system hydraulic pressure in the one or more hydraulically actuated brakes.

2. The hydraulic braking system of claim 1, wherein the threshold speed value indicates the aircraft is essentially stopped.

3. The hydraulic braking system of claim 1, further comprising crew-operated brake pedals capable of supplying a differential pedal braking pressure, and wherein the electronic brake system controller is further configured to suspend the parking signal when the differential pedal braking pressure is above a pedal braking threshold, thereby enabling a pedal-controlled differential braking, the electronic brake system controller further configured to resume sending the parking signal responsive to the park-select signal when the differential pedal braking pressure is below the pedal braking threshold.

4. The hydraulic braking system for an aircraft of claim 1, wherein:
on command of the electronic brake system controller, the brake control valve applies a lesser parking pressure in response to the crew-controlled park brake selector having been selected, said lesser parking pressure being a pressure less than a maximum pressure normally provided by the brake system hydraulic supply;
the electronic brake system controller further configured to electronically compare the lesser parking pressure to the brake system hydraulic pressure and to send a signal to close the park-on-return valve only if the brake system hydraulic pressure has reduced to a level equal to the lesser parking pressure, thereby causing the park-on-return valve to remain open to allow the brake system hydraulic pressure to be controlled to the lesser parking pressure until the brake system hydraulic pressure has bled down to equal the lesser parking pressure, then closing the park-on-return valve to trap the brake system hydraulic pressure in the one or more hydraulically actuated brakes.

5. A portion of an aircraft hydraulic braking system comprising:
a first brake and a second brake each hydraulically operated;
a brake system hydraulic supply pressure;
a brake system return pressure;
an electronic brake system controller, the electronic brake system controller providing a signal to a valve to open or to close;
a first brake control valve, responsive to the electronic brake system controller to apply the first brake, and a second brake control valve, responsive to the electronic brake system controller to apply the second brake;
a first shutoff valve and a second shutoff valve, each hydraulically connected to the brake system hydraulic supply pressure and the brake system return pressure, the first shutoff valve providing a first output pressure to the first brake control valve in response to a first signal from the electronic brake system controller to open and apply the brake system hydraulic supply pressure. and alternatively providing the brake system return pressure in response to the first signal from the electronic brake system controller to close; and the second shutoff valve providing a second output pressure to the second brake control valve in response to a second signal from the electronic brake system controller to close and apply the brake system hydraulic supply pressure when commanded to open and alternatively providing the brake system return pressure in response to the second signal from the electronic brake system controller to close;
a first paired wheel shuttle interposed between the first brake control valve and the first brake and hydraulically connected to the first brake control valve, the first brake, the second brake, and having a first larger area sensing port hydraulically connected to the first shutoff valve, and a first smaller area sensing port hydraulically connected to the second shutoff valve;
a second paired wheel shuttle interposed between the second brake control valve and the second brake and hydraulically connected to the second brake control valve, the second brake, the first brake, and having a second larger area sensing port hydraulically connected to the second shutoff valve, and a second smaller area sensing port hydraulically connected to the first shutoff valve;
when the first shutoff valve is open to port brake hydraulic system supply pressure to the first larger area sensing port, the first paired wheel shuttle hydraulically connects the first brake control valve to the first brake and blocks its connection to the second brake; but if, in response to a first brake control fault having been detected, the electronic brake system controller provides the first signal to close to the first shutoff valve, the brake system return pressure acting on the first larger area sensing port allows the brake system hydraulic supply pressure from the second shutoff valve acting on the first smaller area sensing port to actuate the first paired wheel shuttle to block its connection to the first brake control valve and hydraulically connect the first brake to the second brake instead, thereby enabling the second brake control valve to control both the first brake and the second brake, the electronic brake system controller further providing paired wheel antiskid control to both the first brake and the second brake;
and similarly, in response to a second brake control fault having been detected instead of the first brake control fault, the second paired wheel shuttle is operative to enable the first brake control valve to control both the first brake and the second brake, further providing paired wheel antiskid control to both the first brake and the second brake.

6. A hydraulic braking system for an aircraft comprising:
an aircraft hydraulic supply providing a hydraulic pressure;
an aircraft hydraulic return;
a plurality of brakes, a brake being hydraulically actuated;
controls comprising a plurality of valves and a plurality of sensors to control and monitor the hydraulic pressure to said plurality of brakes;
said plurality of valves, the plurality of sensors, and the plurality of brakes being partitioned into autonomous groups such that they hydraulically share only the aircraft hydraulic supply and the aircraft hydraulic return;
each autonomous group being housed in a pod comprising a single hydraulic module;
and an accumulator connected to and dedicated to each pod, the accumulator providing a limited source of stored energy to power the pod if the aircraft hydraulic supply is lost.

7. The hydraulic braking system for an aircraft of claim 6, further comprising brake control electronics which command the controls and monitor the plurality of sensors in the pod, the brake control electronics partitioned autonomously to match the controls and sensors in the pod.

8. A hydraulic braking system for an aircraft, comprising:
a plurality of brakes autonomously controlled by a plurality of pods, the plurality of pods arranged with at least two of the plurality of pods dedicated to each side of the aircraft, thus limiting a worst case failure to losing no more than half of the plurality of brakes on one side of the aircraft and none of the plurality of brakes on the other side.
